(19) United States
(12) Patent Application Publication
(10) Pub. No.: US 2025/0302099 A1
(43) Pub. Date: Oct. 2, 2025

(54) SOFT VAPORIZING CORE

(71) Applicant: HUIZHOU HAPPY VAPING TECHNOLOGY LIMITED, Huizhou, Guangdong (CN)

(72) Inventors: Guangrong Lin, Huizhou, Guangdong (CN); Xianbin Zheng, Huizhou, Guangdong (CN)

(21) Appl. No.: 18/867,014

(22) PCT Filed: Apr. 14, 2023
(86) PCT No.: PCT/CN2023/088317

§ 371 Date: Nov. 19, 2024

(30) Foreign Application Priority Data
May 19, 2022 (CN) 202221230015.3

(51) Int. Cl. A24F 40/44; A24F 40/10; A24F 40/46; H05B 3/06

(52) U.S. Cl. CPC A24F 40/44; A24F 40/10; A24F 40/46; H05B 3/06; H05B 2203/016; H05B 2203/021

(57) ABSTRACT

A soft vaporizing core comprises a support (1), a heating element (2), and a soft liquid guiding element (3). The support (1) has an upper flat surface (11) and a lower flat surface (12) and is provided with a support through hole (10) in middle. The heating element (2) comprises a sheet-like heating resistance (21) having a conductive path, the heating resistance (21) is disposed in the support through hole (10) and is aligned with the upper flat surface (11) of the support (1), and the soft liquid guiding element (3) is disposed on the upper flat surface (11) of the support. The soft vaporizing core can achieve a low material cost, a simple structure, and a high production efficiency, and achieve sufficient liquid supply and great vaporization amount. It can provide pure taste and is not prone to a burned taste, improving user experience.

### TECHNICAL FIELD

The disclosure relates to the technical field of e-cigarette vaporizing cores, and more particularly, the disclosure relates to a soft vaporizing core.

### BACKGROUND

An electronic cigarette generally includes a battery part and a vaporizer. Herein, the battery part may be mounted with a battery for supplying power to the vaporizer. The vaporizer may be provided with a vaporizing core, which at least comprises a liquid guiding element and a heating element. The heating element can atomize the vaporizing liquid into vapor fog for users to vape when powered on. The vaporizing liquid is namely the to-be-vaporized e-cigarette liquid. The electronic cigarette, as a vaporizing device for the vaporizing liquid, can heat and atomize the vaporizing liquid stored in the electronic cigarette into vapor fog, aerosol, vapor or the like for users to vape.

The vaporizing core of electronic cigarettes in the market generally has a structure in which a liquid guiding cotton string is wound around a heating wire and a structure in which a heating resistance is disposed on the bottom of a porous ceramic body.

Herein, based on the structure in which the liquid guiding cotton string is wound around the heating wire, a relatively small amount of vapor can be produced during operation due to the small cross-sectional area of the liquid guiding cotton string that conducts the vaporizing liquid. Furthermore, during high-temperature operation, the poor sealing between the vaporizing base and the liquid guiding cotton string may lead to liquid leakage.

Herein, based on the structure in which the heating resistance is disposed on the bottom of porous ceramic body, the porous ceramic body has numerous unordered micro-pores. After a long period of operation, macromolecules, micro-particles, carbohydrates and the like contained in the e-cigarette liquid may easily accumulate and gum up the micro-pores of the porous ceramic body. Furthermore, they may be prone to charring at high temperatures to produce a burned taste. In such a case, it may result in reduced vapor amount, inconsistent tastes, impure taste, and even the burned taste when a user vapes.

In addition, the porous ceramic body has a complicated manufacturing process, a high cost, and a low production efficiency. Moreover, the porous ceramic body, which has complex compositions not ruled out heavy metals, has a risk of heavy metal precipitation after a long period of high-temperature operation.

### SUMMARY

### Technical Problems

The disclosure aims to provide a soft vaporizing core to overcome the abovementioned disadvantages in the background. The soft vaporizing core has a low cost, a simple structure, and a high production efficiency and meanwhile can achieve sufficient liquid supply, great vaporization amount, and pure taste, and is not prone to a burned taste.

### Technical Solutions

The disclosure provides a technical solution as follows. A soft vaporizing core comprises a support, a heating element, and a soft liquid guiding element. The support has an upper flat surface and a lower flat surface and is provided with a support through hole in middle, the heating element comprises a sheet-like heating resistance having a conductive path, the heating resistance is disposed in the support through hole, and the soft liquid guiding element is disposed on the heating resistance.

Preferably, a permeable sheet having permeation holes may be further provided, and the permeable sheet is placed between the soft liquid guiding element and the heating resistance.

Preferably, the permeation holes of the permeable sheet may be micro-pores.

Preferably, the support may be integrally provided with a surrounding wall extending upwards along an outer edge of the upper flat surface, and the soft liquid guiding element may be disposed inside the surrounding wall.

Preferably, the soft liquid guiding element may be formed as a block-shaped body.

Preferably, the soft liquid guiding element may be constructed by two or more than two layers of block-shaped bodies stacked together.

Preferably, a supporting sheet provided with a plurality of liquid through holes may be placed between the block-shaped bodies.

Preferably, the soft liquid guiding element may be made of at least one of materials including organic cotton, ceramic fiber cotton, glass fiber cotton, PP fiber, nylon fiber, non-woven fabric, and PET fiber.

Preferably, the heating element may further comprise electrode contact disks connected with two ends of the heating resistance, and the electrode contact disks may be disposed on the lower flat surface of the support and positioned on two sides of the support through hole.

Preferably, on two sides of the heating resistance and the electrode contact disks, a plurality of fixing claws are provided, which extend into an interior of the support.

### Advantages

The soft vaporizing core of the disclosure has advantages as follows. The soft vaporizing core has the simple structure and can be easily mounted into the vaporizer, whereby the production efficiency can be improved. As the soft liquid guiding element conducts the vaporizing liquid from top to bottom, it achieves a large area for conducting and heating the vaporizing liquid, and avoids the shortcomings of the liquid guiding cotton string including small conduction area for conducting vaporizing liquid, small amount of vapor produced during operation, and being prone to liquid leakage during high-temperature operation. In addition, as the soft liquid guiding element for conducting the vaporizing liquid has a loose fiber structure, it eliminates the need for microporous conduction and thus avoids the shortcomings that, macromolecules, micro-particles, carbohydrates and the like contained in the vaporizing liquid may easily accumulate and gum up the micro-pores of the porous ceramic body and may be prone to charring at high temperatures to produce a burned taste during operation of the porous ceramic body. Hence, it can maintain great vaporization amount and consistent and pure taste, prevent burned taste, and improve user experience. Due to low cost of soft raw materials of the soft liquid guiding element, elimination of sintering process, and simple processing and simple structure, the cost can be significantly reduced and the production efficiency can be improved. Additionally, as the material of the soft liquid guiding element has simple composition without heavy metals, there is no risk of heavy metal precipitation during high-temperature operation of the soft vaporizing core.

### BRIEF DESCRIPTION OF THE DRAWINGS

FIG. 1 is a perspective view of a soft vaporizing core according to an embodiment 1 of the disclosure;

FIG. 2 is an exploded perspective view of the soft vaporizing core according to the embodiment 1 of the disclosure;

FIG. 3 is a perspective view 1 illustrating a support in combination with a heating element according to the embodiment 1 of the disclosure;

FIG. 4 is a perspective view 2 illustrating the support in combination with the heating element according to the embodiment 1 of the disclosure;

FIG. 5 is an exploded perspective view illustrating the support and the heating element according to the embodiment 1 of the disclosure;

FIG. 6 is an exploded perspective view of a soft vaporizing core according to an embodiment 2 of the disclosure;

FIG. 7 is a perspective view illustrating a support in combination with a heating element according to an embodiment 3 of the disclosure;

FIG. 8 is a cross-sectional view illustrating the support in combination with the heating element according to the embodiment 3 of the disclosure;

FIG. 9 is a cross-sectional view of a soft vaporizing core according to the embodiment 3 of the disclosure;

FIG. 10 is a cross-sectional view of a soft vaporizing core according to an embodiment 4 of the disclosure;

FIG. 11 is an exploded perspective view of the soft vaporizing core according to the embodiment 4 of the disclosure;

FIG. 12 is a top view of a supporting sheet according to the embodiment 4 of the disclosure.

### DETAILED DESCRIPTION OF ILLUSTRATED EMBODIMENTS

For convenience of description, the soft vaporizing core is vertically disposed in such a manner that the soft liquid guiding element faces upwards, and the terms such as “upper”, “lower”, “upper portion”, “lower portion”, “upper end”, “lower end”, “upwards”, and “downwards” as used herein for illustrating the components, refer to up and down position and orientation relationships when the soft vaporizing core is vertically disposed in such a manner that the soft liquid guiding element faces upwards.

### Embodiments of the Disclosure

The disclosure will be further explained in detail with reference to the drawings and particular embodiments.

### Embodiment 1

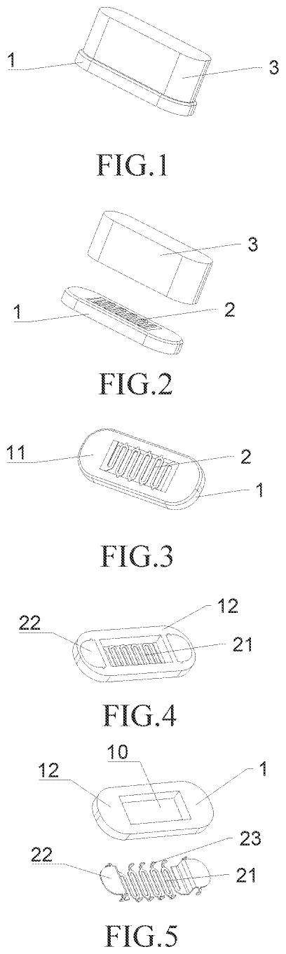

Referring to FIGS. 1-5, a soft vaporizing core of the disclosure mainly consists of a support 1, a heating element 2, and a soft liquid guiding element 3. Herein, the support 1 has an upper flat surface 11 and a lower flat surface 12, and is provided with a support through hole 10 in the middle. The heating element 2 includes a sheet-like heating resistance 21 with a conductive path in a certain shape. The heating resistance 21 is disposed in the support through hole 10. In the embodiment, the heating resistance 21 is aligned or substantially aligned with the upper flat surface 11 of the support 1. The soft liquid guiding element 3 is disposed on the upper surface of the heating resistance 21, with its bottom portion abutting on the heating resistance 21, such that the vaporizing liquid contained in the soft liquid guiding element 3 can come into contact with the heating resistance 221, and the heating resistance 221 can directly heat and atomize the vaporizing liquid into vapor fog.

In the embodiment, the soft liquid guiding element 3 may be made of organic cotton and formed as a block-shaped body that is cohesive and cannot be easily dispersed. That is, the soft liquid guiding element 3 consists of a block-shaped body. In further embodiments, the soft liquid guiding element 3 may also be made of one or a combination of more materials including ceramic fiber cotton, glass fiber cotton, PP fiber, nylon fiber, non-woven fabric, and PET fiber, all of which are soft materials. Due to low cost of raw materials of the soft liquid guiding element 3, elimination of sintering process, simple processing and simple structure, and easy mounting into the vaporizer, the cost can be significantly reduced and the production efficiency can be improved. Additionally, as the material of the soft liquid guiding element 23 has simple composition without heavy metals, there is no risk of heavy metal precipitation during high-temperature operation of the soft vaporizing core.

During operation, the soft liquid guiding element 3 conducts the vaporizing liquid from top to bottom. Its block-shaped structure achieves a large area for conducting and heating the vaporizing liquid, and avoids the shortcomings of the liquid guiding cotton string including small conduction area for conducting vaporizing liquid, small amount of vapor produced during operation, and being prone to liquid leakage during high-temperature operation. As the soft liquid guiding element 3 uses the abovementioned soft cotton-like materials which all have a loose fiber structure, the vaporizing liquid can be conducted through the gaps among the fiber structures, without the need for microporous conduction. Hence, it can achieve quick liquid conduction and maintain a greater vaporization amount. Compared to rigid porous ceramic bodies, it can avoid the shortcomings that macromolecules, micro-particles, carbohydrates and the like contained in the vaporizing liquid may easily accumulate and gum up the micro-pores and may be prone to a burned taste at high temperatures.

Herein, the heating element 2 further comprises electrode contact disks 22 connected with both ends of the heating resistance 21. The electrode contact disks 22 are disposed on the lower flat surface of the support and positioned on both sides of the support through hole 10. The electrode contact disks 22 allow external electrodes to abut thereon, to supply power.

On two sides of the heating resistance 21 and the electrode contact disks 22, several fixing claws 23 are provided, which extend into the interior of the support 1. The fixing claws 23 facilitate firmer fixation on the vaporizing core support 1. In the disclosure, the support 1 may be made of heat-resistant plastic materials. The heating element 2 can be placed in the mold before the injection molding of the support 1, such that it can be formed integrally with the support 1. In particular, as the fixing claws 23 are molded in the support 1, they can be more firmly connected, preventing the heating element 2 from detaching from the support.

In the embodiment, the conductive path of the heating resistance 21 may be designed in a shape of several repeated S. In further embodiments, it may also be designed in other shapes and thus is not limited to the S-shape. The heating resistance 21 is generally composed of a metal heating resistance. The soft liquid guiding element 3 can absorb, store, and conduct the vaporizing liquid. The heating resistance 21 abuts against the lower portion of the soft liquid guiding element 3. Thus, in the case that the heating resistance 21 generates heat when powered on, it heats, vaporizes and atomizes the vaporizing liquid in the lower portion of the soft liquid guiding element 3 into vapor fog, which then can be dispersed downwards through the support through hole 10.

### Embodiment 2

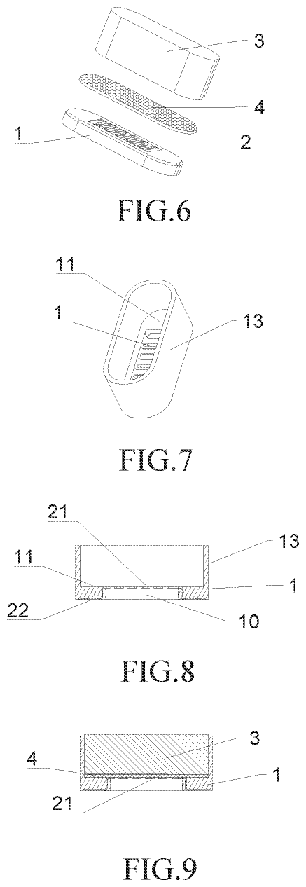

Referring to FIG. 6, on the basis of the embodiment 1 described above, the soft vaporizing core in the present embodiment further comprises a permeable sheet 4 provided with permeation holes (not shown in the drawings). The permeable sheet 4 is positioned between the soft liquid guiding element 3 and the support 1. Herein, the permeation holes of the permeable sheet 4 are micro-pores. The permeable sheet 4 may be a thin sheet with a thickness set in a range of 0.5 mm-2 mm. the diameter of the permeation holes of the permeable sheet 4 may be set between 50 μm and 2 mm. In the embodiment, the permeable sheet 4 serves to support the soft liquid guiding element 3 from below and prevents it from deforming or sagging under a long period of high-temperature operation. Meanwhile, it allows the vaporizing liquid stored in the soft liquid guiding element 3 to be slowly released onto the heating resistance 21 through the permeation holes. During operation, it can balance the evaporation amount of the vaporizing liquid with the permeation amount. When the vaporization is inactivated, the vaporizing liquid flowing through the permeation holes can achieve another kind of balance due to the surface tension, preventing dripping or leakage of the vaporizing liquid. The permeable sheet 4 may be made very thin and made of high-temperature-resistant, non-conductive materials, such as plastic, silicone, porous ceramic body, diatomaceous earth, etc.

### Embodiment 3

Referring to FIGS. 7-9, on the basis of the embodiment 2 described above, the support 1 in the present embodiment is integrally provided with a surrounding wall 13 extending upwards along the outer edge of the upper flat surface 11. In other words, the support 1 includes two portions, i.e., the portion of the bottom wall and the portion of the surrounding wall. The soft liquid guiding element 3 is disposed inside the surrounding wall 13, and the permeable sheet 4 is placed between the soft liquid guiding element 3 and the inner bottom of the support 1.

The surrounding wall 13 serves to laterally surround and support the soft liquid guiding element 3 from the outer periphery, preventing the vaporizing liquid stored in the liquid guiding element 3 from leaking outside.

Due to the structure with the surrounding wall in the embodiment, the vaporizing core achieves the integral structure in a simple design. It is easy to mount into the vaporizer, thereby enhancing production efficiency.

### Embodiment 4

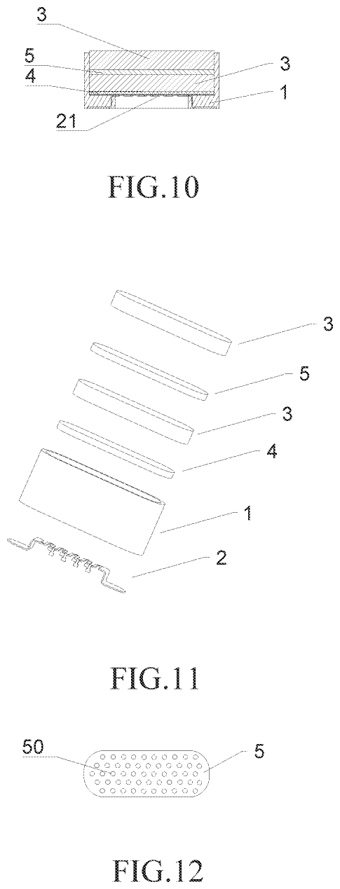

Referring to FIGS. 10-12, on the basis of the embodiment 3 described above, the soft liquid guiding element 3 in the present embodiment is constructed by stacking two layers of block-shaped bodies, with a supporting sheet 5 placed between the block-shaped bodies. The supporting sheet 5 is provided with several liquid through holes 50, through which the vaporizing liquid can be conducted between the two layers of block-shaped bodies. The two layers of soft liquid guiding element 3 allow for the storage of more vaporizing liquid, thereby making it possible for the vaporizing core to release more vaporizing liquid for vaporization during operation and thus increasing vaporization amount. In the case that the soft liquid guiding element 3 containing more vaporizing liquid will be more prone to sagging and deformation, the supporting sheet 5 can serve to internally support the soft liquid guiding element 3 and prevent it from sagging and deforming. The supporting sheet 5 may be made of a rigid sheet, with materials including rigid plastics, metallic materials, etc.

Due to the low cost of raw materials of the soft liquid guiding element, the elimination of sintering process, the simple processing, and the simple structure, it is easy to mount the soft vaporizing core of the disclosure into the vaporizer, thereby improving production efficiency. As the soft liquid guiding element conducts the vaporizing liquid from top to bottom, it achieves a large area for conducting and heating the vaporizing liquid, and avoids the shortcomings of the liquid guiding cotton string including small conduction area for conducting vaporizing liquid, small amount of vapor produced during operation, and being prone to liquid leakage during high-temperature operation. In addition, as the soft liquid guiding element for conducting the vaporizing liquid has a loose fiber structure, it eliminates the need for microporous conduction and thus avoids the shortcomings that, macromolecules, micro-particles, carbohydrates and the like contained in the vaporizing liquid may easily accumulate and gum up the micro-pores of the porous ceramic body and may be prone to charring at high temperatures to produce a burned taste during operation of the porous ceramic body. Hence, it can maintain great vaporization amount and consistent and pure taste, prevent burned taste, and improve user experience. Due to low cost of soft raw materials of the soft liquid guiding element, elimination of sintering process, and simple processing and simple structure, the cost can be significantly reduced and the production efficiency can be improved. Additionally, as the material of the soft liquid guiding element has simple composition without heavy metals, there is no risk of heavy metal precipitation during high-temperature operation of the soft vaporizing core.

### INDUSTRIAL APPLICABILITY

All the above are merely preferred embodiments of the disclosure. The present invention is intended to cover all equivalent arrangements and modifications derived from the claims of the present invention.

1. A soft vaporizing core, characterized in that, the soft vaporizing core comprises a support, a heating element, and a soft liquid guiding element, wherein the support has an upper flat surface and a lower flat surface and is provided with a support through hole in middle, the heating element comprises a sheet-like heating resistance having a conductive path, the heating resistance is disposed in the support through hole, and the soft liquid guiding element is disposed on the heating resistance.

2. The soft vaporizing core according to claim 1, characterized in that, the soft vaporizing core further comprises a permeable sheet provided with permeation holes, and the permeable sheet is placed between the soft liquid guiding element and the heating resistance.

3. The soft vaporizing core according to claim 2, characterized in that, the permeation holes of the permeable sheet are micro-pores.

4. The soft vaporizing core according to claim 1, characterized in that, the support is integrally provided with a surrounding wall extending upwards along an outer edge of the upper flat surface, and the soft liquid guiding element is disposed inside the surrounding wall.

5. The soft vaporizing core according to claim 1, characterized in that, the soft liquid guiding element is formed as a block-shaped body.

6. The soft vaporizing core according to claim 5, characterized in that, the soft liquid guiding element is constructed by two or more than two layers of block-shaped bodies stacked together.

7. The soft vaporizing core according to claim 6, characterized in that, a supporting sheet provided with a plurality of liquid through holes is placed between the block-shaped bodies.

8. The soft vaporizing core according to claim 1, characterized in that, the soft liquid guiding element is made of at least one of materials including organic cotton, ceramic fiber cotton, glass fiber cotton, PP fiber, nylon fiber, non-woven fabric, and PET fiber.

9. The soft vaporizing core according to claim 1, characterized in that, the heating element further comprises electrode contact disks connected with two ends of the heating resistance, and the electrode contact disks are disposed on the lower flat surface of the support and positioned on two sides of the support through hole.

10. The soft vaporizing core according to claim 9, characterized in that, on two sides of the heating resistance and the electrode contact disks, a plurality of fixing claws are provided, which extend into an interior of the support.
